(19) United States
(12) Patent Application Publication
(10) Pub. No.: US 2025/0278608 A1
(43) Pub. Date: Sep. 4, 2025

(54) Generating a Descriptor of Second Modality Data Associated With Data of a First Modality

(71) Applicant: Oxa Autonomy Ltd, Oxford (GB)

(72) Inventors: Horia Porav, Oxford (GB); Paul Newman, Oxford (GB); Ben Upcroft, Oxford (GB)

(73) Assignee: Oxa Autonomy Ltd, Oxford (GB)

(21) Appl. No.: 18/862,513

(22) PCT Filed: May 2, 2023
(86) PCT No.: PCT/GB2023/051162

§ 371 Date: Nov. 1, 2024

(30) Foreign Application Priority Data
May 3, 2022 (GB) 2206457.0

(51) Int. Cl. G06N 3/0455; G01S 13/86

(52) U.S. Cl. CPC G06N 3/0455; G01S 13/86

(57) ABSTRACT

The present invention relates to a computer-implemented method of generating a descriptor associated with data of a first modality. The method comprises: receiving first data associated with a first modality, and second data associated of a second modality, wherein the first and second modalities are different; generating respective first and second descriptors corresponding to the respective first and second modalities by encoding the first and second data using respective first and second encoders, the first and second encoders respectively trained based on first training data of the first modality and second training data of the second modality; transforming the first descriptor into a third descriptor, the third descriptor corresponding to the second modality; and storing the third descriptor in a database

### FIELD

The subject-matter of the present disclosure relates to a computer-implemented method of generating a descriptor for data of a first modality, a computer implemented method of training a descriptor generator for generating a descriptor for data of the first modality, a computer-implemented method of retrieving data of the first modality, and a transitory, or non-transitory, computer-readable medium.

### BACKGROUND

Autonomous vehicles (AV) include various sensors of different sensor types. Each sensor type records data of a different modality. The different modalities can be paired when captured simultaneously by sensors on a particular AV. For example, paired data may be data from two or more modalities that capture the same scene. The paired data can be labelled as such. The paired data can be retrieved for various purposes, for example to be compared to current data to control the AV.

However, some AVs may not capture paired data. In such cases, data retrieval becomes problematic because it is not possible to determine which data corresponds to which scene if data from different modalities are labelled independently.

It is an object of the present disclosure to address such issues and improve on the prior art.

### SUMMARY

According to an aspect, there is provided a computer-implemented method of generating a descriptor associated with data of a first modality. The method comprises: receiving first data associated with a first modality, and second data associated of a second modality, wherein the first and second modalities are different; generating respective first and second descriptors corresponding to the respective first and second modalities by encoding the first and second data using respective first and second encoders, the first and second encoders respectively trained based on first training data of the first modality and second training data of the second modality; transforming the first descriptor into a third descriptor, the third descriptor corresponding to the second modality; and storing the third descriptor in a database.

The preceding aspect may be expressed differently as a computer-implemented method of generating a descriptor associated with data of a first modality recorded by a sensor of the first modality, an autonomous vehicle comprising the sensor of the first modality and a sensor of a second modality, the method comprising: recording, by the sensor of the first modality, first data associated with the first modality, and recording, by the sensor of the second modality, second data associated with the second modality, wherein the first and second modalities are different; generating respective first and second descriptors corresponding to the respective first and second modalities by encoding the first and second data using respective first and second encoders, the first and second encoders respectively trained based on first training data of the first modality and second training data of the second modality; transforming the first descriptor into a third descriptor, the third descriptor corresponding to the second modality; and storing the third descriptor in a database.

In an embodiment, the transforming may comprise: decoding the first descriptor into decoded third data corresponding to the second modality using a decoder, the decoder trained to generate data of the second modality; and encoding the third data to generate the third descriptor corresponding to the second modality using a third encoder.

In an embodiment, the first modality and the second modality may respectively correspond to modality of a sensor used to record the respective data.

In an embodiment, the sensor may comprise one of a LiDAR sensor, a RADAR sensor, and a camera. In other words, wherein the sensor of the first modality and the second of the second modality may each comprise one of a LIDAR sensor, a RADAR sensor, an a camera

In an embodiment, the first encoder and the second encoder may be from respective auto encoders, and wherein the respective first descriptor and second descriptor may be a representation corresponding to a bottle neck of the respective auto encoder.

In an embodiment, the auto encoder may be a variational auto encoder.

According to another aspect of the present invention, there is provided a computer-implemented method of training a descriptor generator for generating a descriptor associate with data of a first modality, the descriptor generator comprising a first encoder, a second encoder, and a transformer. The method comprises: training the first encoder to generate a first descriptor corresponding to first data of a first modality using first training data of the first modality; training the second encoder to generate a second descriptor corresponding to second data of a second modality using second training data of the second modality, wherein the first and second modalities are different; and training the transformer to transform the first descriptor into a third descriptor corresponding to the second modality using contrastive learning based on the first and second training data.

In an embodiment, the training the transformer using contrastive learning may comprise: determining a distance between the second descriptor and the third descriptor; and modifying the transformer to reduce the distance.

In an embodiment, the modifying may comprise modifying the transformer to minimise the distance.

In an embodiment, the training the transformer using contrastive learning may comprise: comparing, using a discriminator, the second descriptor and the second descriptor; and determining if the third descriptor is real or fake using the discriminator.

In an embodiment, the descriptor generator may further comprise an inverse transformer, wherein the method may further comprise: transforming the third descriptor into a fourth descriptor using the inverse transformer; computing a distance between the first descriptor and the fourth descriptor; and modifying the inverse transformer to reduce the distance.

In an embodiment, the first modality and the second modality may respectively correspond to a modality used to record the respective data.

In an embodiment, the sensor may comprise one of a LiDAR sensor, a RADAR sensor, and a camera.

In an embodiment, the first encoder and the second encoder may be respectively an encoder of an autoencoder.

In an embodiment, the autoencoder may be a variational autoencoder.

According to another aspect of the present invention, there is provided a computer-implemented method of retrieving data of a first modality. The method comprises: retrieving a descriptor from a database of descriptors associated with data of a second modality; transforming, using an inverse transformer, the retrieved descriptor into a transformed descriptor, the transformed descriptor associated with the first modality, wherein the first and second modalities are different; and retrieving data of the first modality associated with the transformed descriptor from a database.

The preceding aspect may be expressed differently as a computer-implemented method of operating an autonomous vehicle to move, the method comprising: obtaining real-time data from a sensor of a first modality; retrieving a descriptor from a database of descriptors associated with data of a second modality; transforming, using an inverse transformer, the retrieved descriptor into a transformed descriptor, the transformed descriptor associated with the first modality, wherein the first and second modalities are different; decoding, by a decoder, the transformed descriptor of the first modality to generate data of the first modality; comparing the real-time data to the generated data of the first modality; and operating an autonomous vehicle to move based on the comparison.

In an embodiment, the first and second modalities may respectively correspond to a modality of a sensor used to record the respective data.

In an embodiment, the sensor may be one of a LIDAR sensor, a RADAR sensor, or a camera.

In an embodiment, the computer-implemented method may further comprise: obtaining real-time data from a sensor of the first modality; comparing the real-time data to the retrieved data; and operating an autonomous vehicle to move based on the comparison.

According to another aspect of the present invention, there is provided a transitory, or non-transitory, computer-readable medium including instructions stored thereon that when executed by a processor, cause the processor to perform the method of any preceding claim.

### BRIEF DESCRIPTION OF DRAWINGS

The subject-matter of the present disclosure is best understood with reference to the accompanying figures, in which:

FIG. 1 shows a schematic of an AV according to one or more embodiments;

FIG. 2 shows a block diagram of variational autoencoders, one for each modality;

FIG. 3 shows a more detailed block diagram of the variational autoencoders of FIG. 2;

FIG. 4 shows a block diagram of a classifier used to train encoders, from the variational autoencoders from FIG. 2, using paired data;

FIG. 5 shows a block diagram of a distance comparator used to train autoencoders, from the variational autoencoders from FIG. 2, using paired data;

FIG. 6 shows a block diagram representing training decoders, from the variational autoencoders from FIG. 2;

FIG. 7 shows a block diagram of training a transformer for translating a descriptor, from a bottleneck of the variational autoencoder from FIG. 2, and of training an inverse transformer for reverting the translation of the descriptor, using unpaired data, according to one or more embodiments;

FIG. 8 shows a block diagram of the transformer from FIG. 7;

FIG. 9 shows a block diagram of the inverse transformer from FIG. 7;

FIG. 10 shows a block diagram of training a transformer for translating a descriptor, from a bottleneck of the variational autoencoder from FIG. 2, and of training an inverse transformer for reverting the translation of the descriptor, using paired data, according to one or more embodiments;

FIG. 11 shows a block diagram of storing the translated descriptor and updating an index of closest descriptors with the translated descriptor, according to one or more embodiments;

FIG. 12 shows a block diagram representing retrieval of data using the translated descriptor according to one or more embodiments;

FIG. 13 shows a flow chart of a computer-implemented method of generating a descriptor associated with data of a first modality;

FIG. 14 shows a flow chart of a computer-implemented method of training a descriptor generator for generating a descriptor associate with data of a first modality; and

FIG. 15 shows a flow chart of a computer-implemented method of retrieving data of a first modality.

### DESCRIPTION OF EMBODIMENTS

The embodiments described herein are embodied as sets of instructions stored as electronic data in one or more storage media. Specifically, the instructions may be provided on a transitory or non-transitory computer-readable media. When executed by the processor, the processor is configured to perform the various methods described in the following embodiments. In this way, the methods may be computer-implemented methods. In particular, the processor and a storage including the instructions may be incorporated into a vehicle. The vehicle may be an AV.

Whilst the following embodiments provide specific illustrative examples, those illustrative examples should not be taken as limiting, and the scope of protection is defined by the claims. Features from specific embodiments may be used in combination with features from other embodiments without extending the subject-matter beyond the content of the present disclosure.

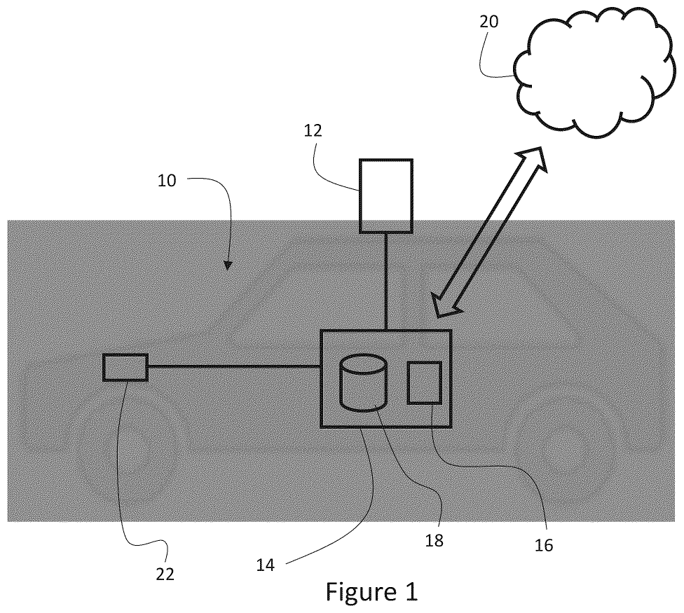

With reference to FIG. 1, an AV 10 may include a plurality of sensors 12. The sensors 12 may be mounted on a roof of the AV 10. The sensors 12 may be communicatively connected to a computer 14. The computer 14 may be onboard the AV 10. The computer 14 may include a processor 16 and a memory 18. The memory may include the non-transitory computer-readable media described above. Alternatively, the non-transitory computer-readable media may be located remotely and may be communicatively linked to the computer 14 via the cloud 20. The computer 14 may be communicatively linked to one or more actuators 22 for control thereof to move the AV 10. The actuators may include, for example, a motor, a breaking system, a power steering system, etc.

The sensors 12 may include various sensor types. Examples of sensor types include LiDAR sensors, RADAR sensors, and cameras. Each sensor type may be referred to as a sensor modality. Each sensor type may record data associated with the sensor modality. For example, the LiDAR sensor may record LIDAR modality data.

The data may capture various scenes that the AV 10 encounters. For example, a scene may be a visible scene around the AV 10 and may include roads, buildings, weather, objects (e.g. other vehicles, pedestrians, animals, etc.), etc.

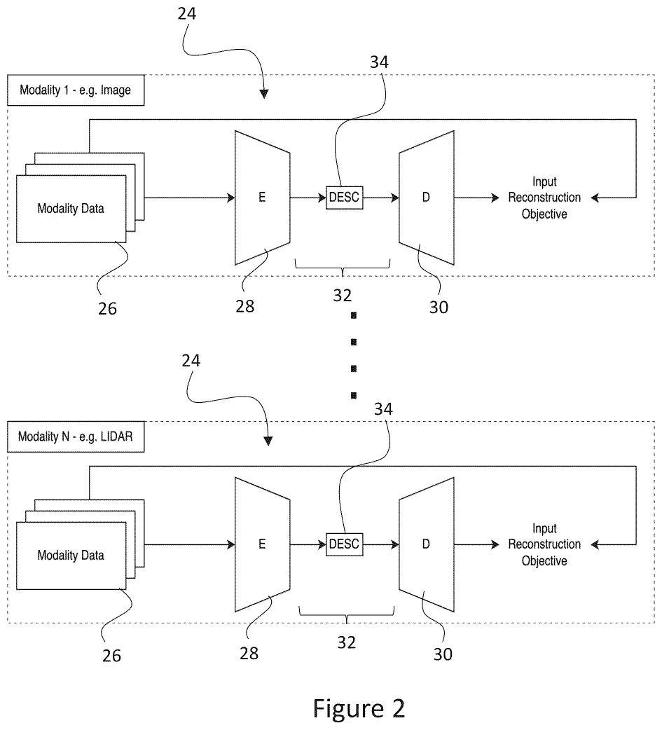

With reference to FIG. 2, for each modality, an autoencoder 24 is trained. The autoencoder may be a variational autoencoder (VAE). The VAE 24 may be configured to receive packets of data 26 in a particular modality, e.g. image data, or LiDAR data. The data packets 26 may each capture a scene. The VAE 24 may include an encoder 28 and a decoder 30. The encoder may reduce the dimensionality of the data packet 26 to a distribution at a bottleneck 32. The distribution may be called a descriptor 34. The decoder 30 may reconstruct the data packet 26 by increasing the dimensionality of the descriptor 34 to be of the same size as the original data packet 26.

To train the VAE 24, an error is calculated between the reconstructed data packet and the original data packet. Back propagation may be used to optimise the encoder and decoder hyperparameters.

The descriptor 34 may be stored in a database. The descriptor 34 may be used to regenerate the scene corresponding to the data packet associated with the descriptor 34. The regenerated scene may be used by the AV 10 (FIG. 1) when moving the AV 10. For example, the regenerated scene can be associated with particular modes of operation. Current sensor data can be compared to the regenerated scene and the AV 10 can be controlled to operate in the associated mode of operation based on how closely the current scene data matches the regenerated scene data. The regenerated scene data may also be used in a simulator to expand the scenarios that the AV 10 is trained to deal with in real time.

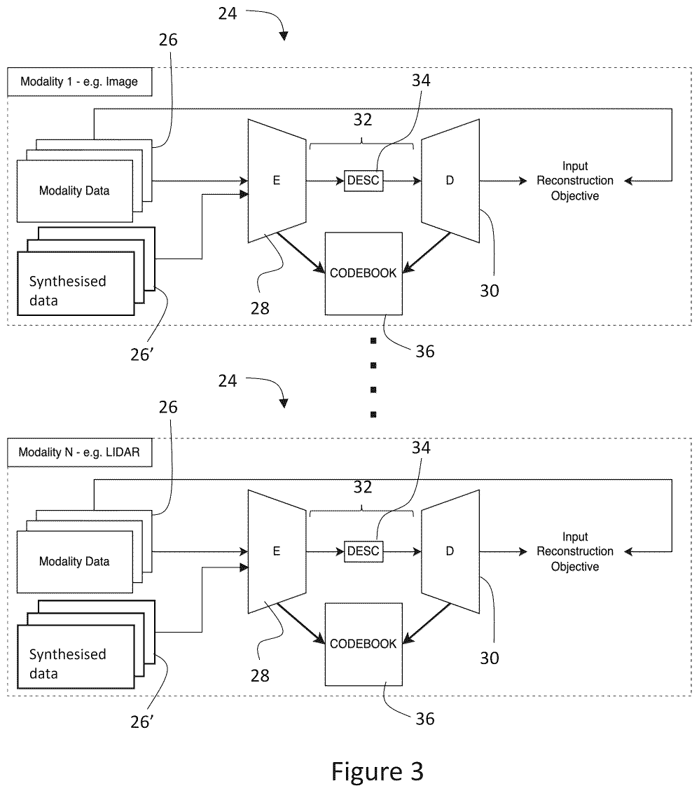

With reference to FIG. 3, the VAE 24 may receive data packets 26 from the sensors. In addition, the VAE 24 may receive synthesized data packets 26′. A synthesized data packet 26′ may be data packets where features within original sensor data packets have been augmented, or data from a simulation. For example, additional objects such as pedestrians or vehicles, or weather states such as rain or fog, may have been added using a generative adversarial network. In this way, the VAE 24 may have a larger data train from which to train.

Typically, VAEs 24 may produce a descriptor having a particular distribution, which may be a Gaussian distribution. However, in one or more embodiments, the distribution may not be Gaussian. The distribution may be different depending upon the features within a scene of the data packet. For example, there may be a distribution for two dynamic objects within the scene, a particular distribution for there being a static vehicle in the scene, and a particular distribution for there being a particular weather state, e.g. fog. A look-up table, called a codebook 36, may be provided. The codebook includes all of the distributions. A hidden layer within the encoder 28 may be extracted which contains the features within the scene as extracted from the original data packet 26, 26′. The features in the hidden layer may be used to identify one or more distributions from the look-up table. Where there are multiple features, multiple distributions may be combined statistically to obtain a distribution for the particular scene.

Because each VAE 24 is trained independently, the descriptors are specific to the modality of the respective modality of the VAE 24. In this way, there is no correlation between descriptors. In other words, it is difficult to compare descriptors derived from data of different modalities. For example, it is possible to compare a descriptor derived from image data to a descriptor derived from LIDAR data. However, a matching scene may not have a comparatively small distance, or zero, e.g. using cosine similarity or Euclidian distance.

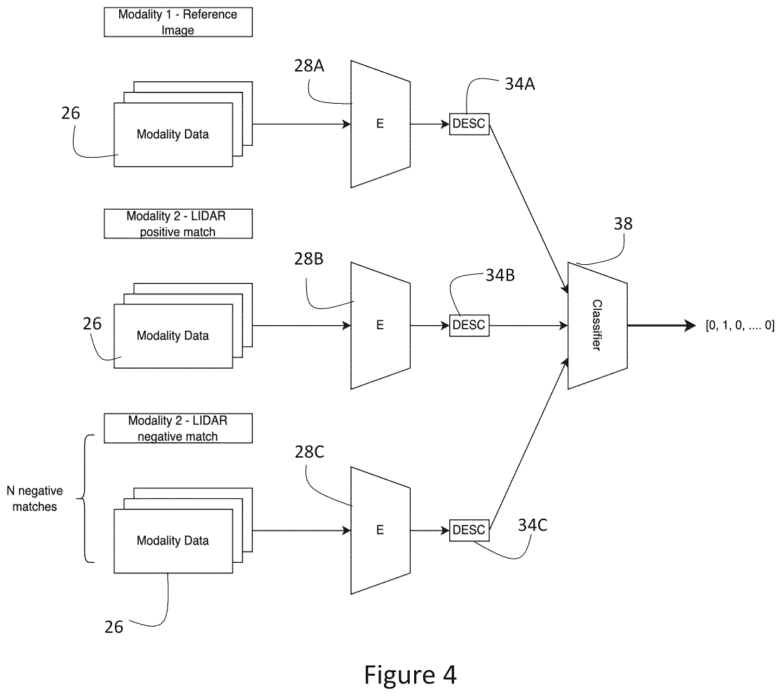

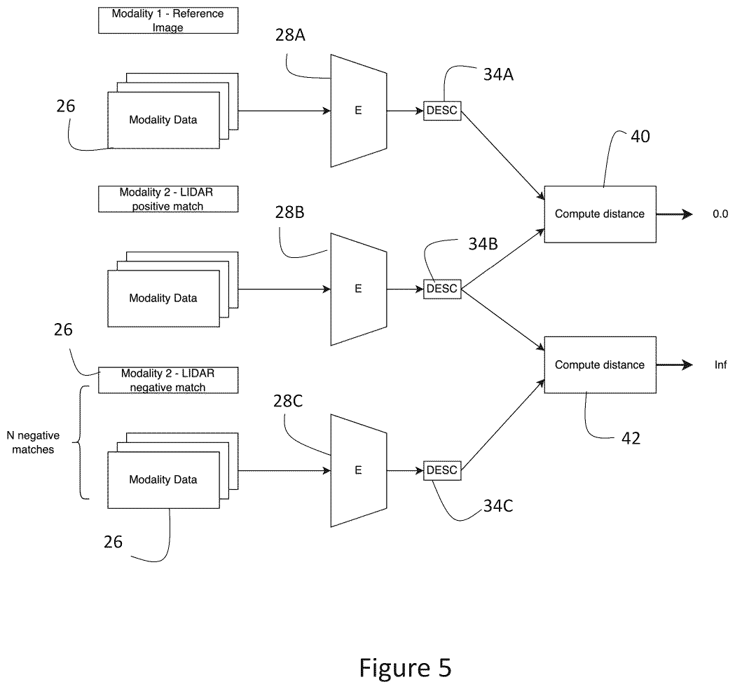

With reference to FIGS. 4 and 5, in order to reduce any discrepancy between descriptors of different modalities, it is possible to use contrastive learning.

With reference to FIG. 4, contrastive learning may be implemented using a classifier 38 as a supervisor to train the respective encoders 28. For example, scenes 26A from a first modality, e.g. an image, may be input to a first encoder 28A. Scenes 26B from a second modality, e.g. LiDAR data, may be input to a second encoder 28B. Scenes from the second modality may also be input to a third encoder 28C. The inputs to the second and third encoders 28A, 28B, may differ in so far as the second encoder inputs may positively match the scenes of the first modality, whereas the scenes input to the third encoder may not match, or negatively match, the scenes of the first modality. The positive and negative matches are known because the data of the first and second modalities are paired. By “paired” we mean that they represent the same scene, and may be synchronised temporally when captured.

The classifier 38 is used to train the parameters of the respective first and second encoders 28A, 28B. By training, we mean that first and second descriptors 34A, 34B, derived from the first and second encoders 28A, 28B, each categorise the scene in the same way. In addition, the third descriptor 34C, derived from the third encoder 28C, categorises the scene differently.

With reference to FIG. 5, contrastive learning may be implemented using first and second distance matchers 40, 42.

The first distance matcher 40 may compute a distance between the first and second descriptors 34A, 34B. The first and second encoders 28A, 28B, are trained to derive first and second descriptors 34A, 34B, which have zero, or at least a very small or negligible, distance. The first distance matcher 40 may compute a distance using Euclidian distance, cosine similarity, a learned matcher (e.g. a neural network), or another distance metric.

The second distance matcher 42 may compute a distance between the second and third descriptors 34B, 34C. The second and third encoders 28B, 28C, are trained to derive second and third descriptors 34B, 34C, which have a very large distance which may tend to infinity. The second distance matcher 42 may compute a distance using Euclidian distance, cosine similarity, a learned matcher (e.g. a neural network), or another distance metric.

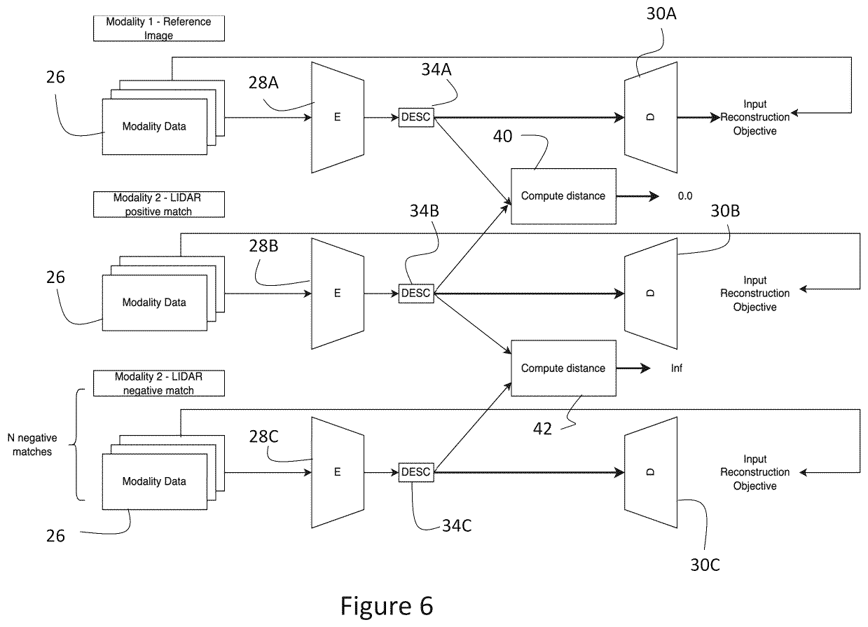

FIG. 6 represents a block diagram describing how the respective decoders are trained in addition to training the encoders using contrastive learning as shown in FIG. 5.

For example, there are first to third decoders 30A-30C to be trained. Each decoder 30A-30C corresponds to a respective first to third encoder 28A-28C. Each decoder is trained by comparing the reproduced scene in a given modality against the original scene 26 for that modality, and modifying the respective decoder's hyperparameters to reduce, or minimise, an error.

The algorithms described with reference to FIGS. 4 to 6 work well where data is paired. However, where data is unpaired, e.g. from a single modality, it may not be possible to render the descriptors as being comparable when they are derived from different modalities.

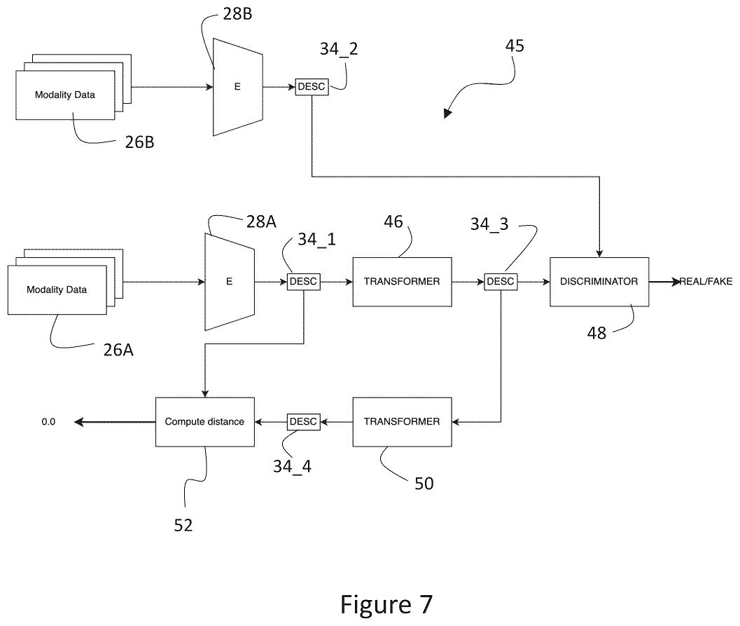

To alleviate this issue, an embodiment of a descriptor generator 45 according to FIG. 7 is provided.

With reference to FIG. 7, the descriptor generator 45 includes a first encoder 28A, a second encoder 28B, a transformer 46, a discriminator 48, an inverse transformer 50, and a distance matcher 52. First training data 26A (e.g. sample scenes) and second training data 26B (e.g. sample scenes) in respective first and second modalities 26A, 26B, are input to first and second encoders 28A, 28B. The first and second encoders 28A, 28B, have been trained as described above with reference to FIGS. 2 and 3. In other words, the first and second encoders 28A, 28B, have been trained independently. The first encoder 28A generates a first descriptor 34_1 corresponding to first data 26A of a first modality using first training data of the first modality. The second encoder 28B generates a second descriptor 34_2 corresponding to second data 26B of a second modality using second training data of the second modality. The first modality and the second modality may be different, in so far as they are obtained by different sensor types. For example, a first modality may be LiDAR sensor data and the second modality may be camera image data.

The transformer 46 may be trained to transform the first descriptor 34_1 into a third descriptor 34_3. The third descriptor may correspond to the second modality. In other words, the transformer 46 is configured to transform the descriptor from the first modality to the second modality such that the third descriptor 34_3 appears as though it has been generated by the first encoder 28A rather than the second encoder 28B.

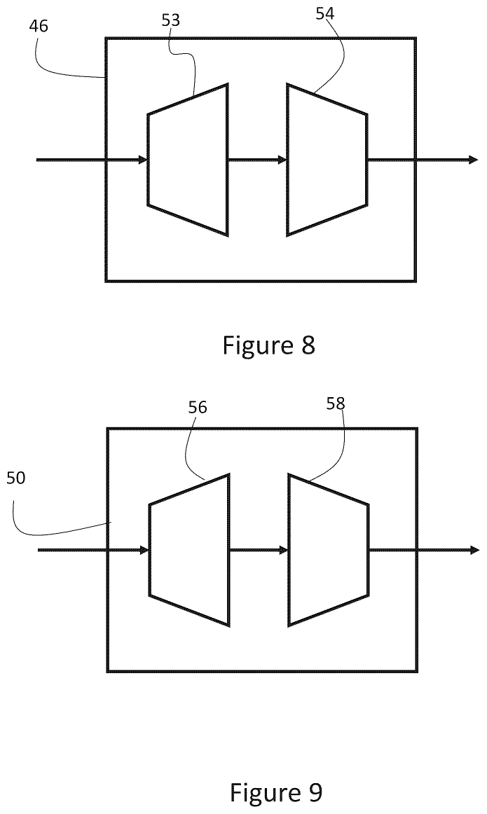

With brief reference to FIG. 8, the transformer 46 includes a decoder 53 and an encoder 54. The decoder 53 is configured to generate third data which is in the first modality, e.g. a camera image. The encoder 54 is configured to generate the third descriptor 34_3. In this way, the third descriptor 34_3 corresponds to the second modality.

With further reference to FIG. 7, the descriptor generator 45 compares, using the discriminator 48, the second descriptor 34_2 and the third descriptor 34_3. The discriminator 48 is configured to determine if the third descriptor 34_3 is real or fake. For example, a real determination would mean that the transformer 46 has managed to generate a third descriptor 34_3 that the discriminator 48 believes is derived directly from second modality data samples 26B, rather than being a converted form of first modality data samples 26A. A fake determination would mean that the transformer 46 has generated a third descriptor 34_3 that the discriminator 48 does not believe to be derived directly from second modality data 26B. The discriminator 48 may be a neural network.

If the discriminator 48 determines that the third descriptor 34_3 is fake, the transformer 46 is changed. In particular, the parameters of the transformer 46 are modified until the determination is of a real descriptor.

The inverse transformer 50 may transform the third descriptor 34_3 into a fourth descriptor 34_4.

With brief reference to FIG. 9, the inverse transformer 50 may include a decoder 56 and an encoder 58. The decoder 56 may generate data, e.g. LiDAR data, in the first modality using the third descriptor which corresponds to the second modality, e.g. a camera image. The encoder 58 may generate a fourth descriptor 34_4 from the generated second modality data.

With further reference to FIG. 7, distance matcher 52 is configured to compute a distance between the first descriptor and the fourth descriptor. The distance matcher 52 may perform the distance matching using any of a Euclidian distance, a cosine similarity, a learned matcher (e.g. a neural network), or any other suitable distance metric. The distance may be taken to be an error value. The inverse transformer 50 may be modified to reduce, or minimise, the distance. In certain circumstances, the transformer 46 may also be modified to reduce, or minimise, the distance.

One reason for the distance matcher 52 is to avoid a situation where the transformer 46 generates a third descriptor 34_3 that is deemed to be real, but has different features than the original data 26A. For example, the original image may include three pedestrians and four dynamic vehicles. If the third descriptor 34_3 generates an image that has no pedestrians, but two animals and only static cars, but has been deemed to be real in so far as being derived from the second modality.

In this way, the data from a first modality can be indexed using the descriptor in a target modality, e.g. the second modality, which is different from the first modality. Therefore, all modalities may be indexed using descriptors that have been transformed into the target modality. As a result, the data does not need to be paired data in order to be indexed and compared with data from similar or the same scene when derived from a different sensor type.

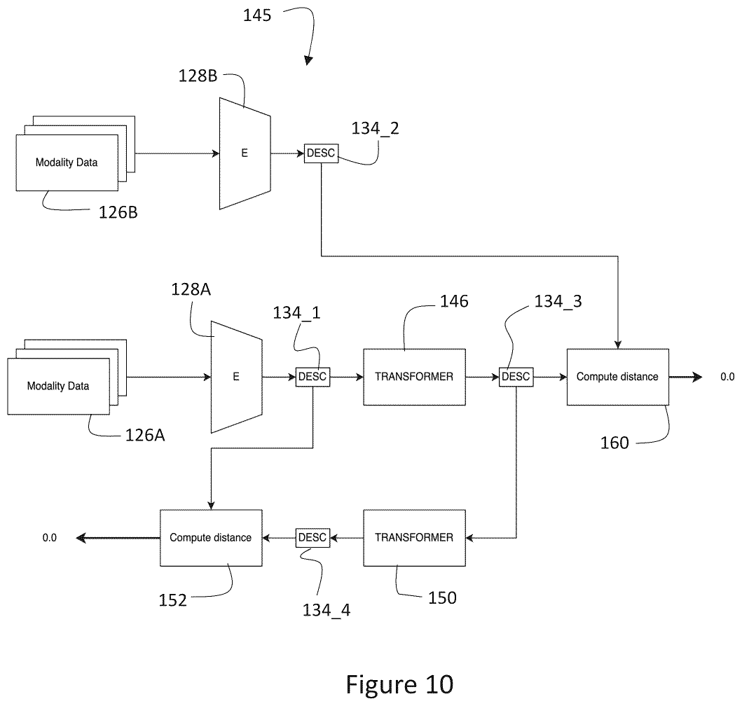

With reference to FIG. 10, an embodiment of the descriptor generator 145 is provided. The descriptor generator 145 is the same as the descriptor generator from FIG. 7 except the discriminator 48 has been replaced with a distance matcher 160. To avoid duplication, only differences between the embodiment of FIG. 7 and the embodiment of FIG. 10 will be described and like features will be prefixed with a 1.

The third descriptor 134_3 is compared, by the distance matcher 160, with the second descriptor 134_2. The distance matcher 160 may compute the distance using Euclidian distance, cosine similarity, a learned matcher (e.g. a neural network), or any suitable matching metric.

The transformer 146 may be modified based on a distance between the second and third descriptors 134_2, 134_3, to reduce, or minimise the distance. For example, the parameters of the transformer 146 may be modified.

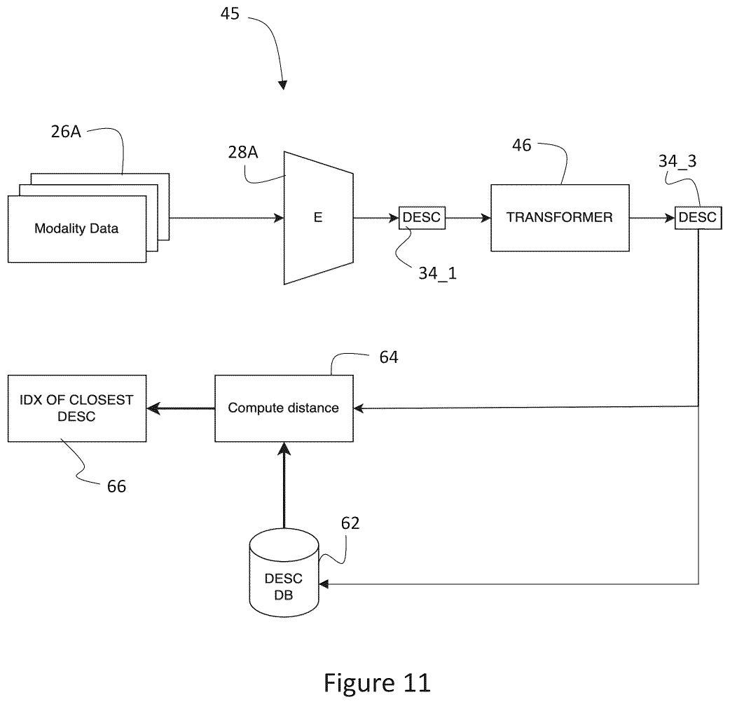

With reference to FIG. 11, the descriptor generator 45 is shown as generating a descriptor for indexing data from a first modality.

First data 26A associated with a first modality (e.g. LiDAR sensor data) may be used as an input to the first encoder 28A. As with embodiments above, the first encoder 28A generates a first descriptor 34_1. The transformer 46 transforms the first descriptor into a third descriptor 34_3, the third descriptor corresponding to a second modality. The third descriptor 34_3 is stored in a database 62. The database 62 also includes other descriptors, all of which correspond to the second modality, either derived directly from sensor data of the second modality or by transformation into the second modality from another modality.

A distance matcher 64 receives the third descriptor directly. The third descriptor 34_3 is compared by the distance matcher 64 to the descriptors in the database 62. The comparison may be made using techniques such as Euclidian distance, cosine similarity, a learned macher such as a neural network, etc. The result of the distance matcher 64 is input to an index of closest descriptors 66.

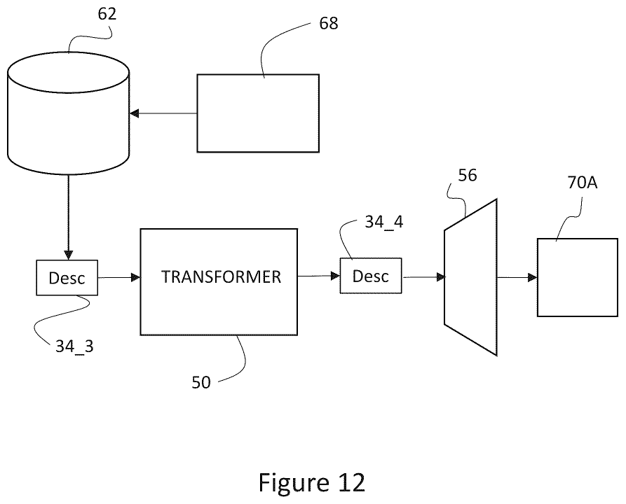

With reference to FIG. 12, a requesting system 68 may request a scene in a first modality. The requesting system may identify the scene by using an index as shown in FIG. 11, for example. The requesting system 68 may retrieve the third descriptor 34_3 from a database 62 of descriptors. The third descriptor 34_3 is associated with data of a second modality, e.g. camera image data.

The inverse transformer 50 may transform the third descriptor 34_3 into the fourth descriptor 34_4 of the first modality. The fourth descriptor 34_4 may be called a transformed descriptor. The transformed descriptor 34_4 may be of the first modality. The fourth descriptor 34_4 may be input to a decoder 56, which may be the decoder from FIG. 9. The decoder 56 may generate a reproduced image 70A of the first modality (e.g. LiDAR data).

During run-time, the computer 14 (FIG. 1) may obtain real-time data from a sensor 12 of the first modality (e.g. a LIDAR sensor). The computer 14 may compare the real-time data to the retrieved data. In this way, the computer 14 may be the requesting system 68. The computer 14 may operate the AV 10 to move based on the comparison. For example, the AV 10 may have traversed a very similar scene before and so may use the trajectory previously used to construct a trajectory to navigate the current scene.

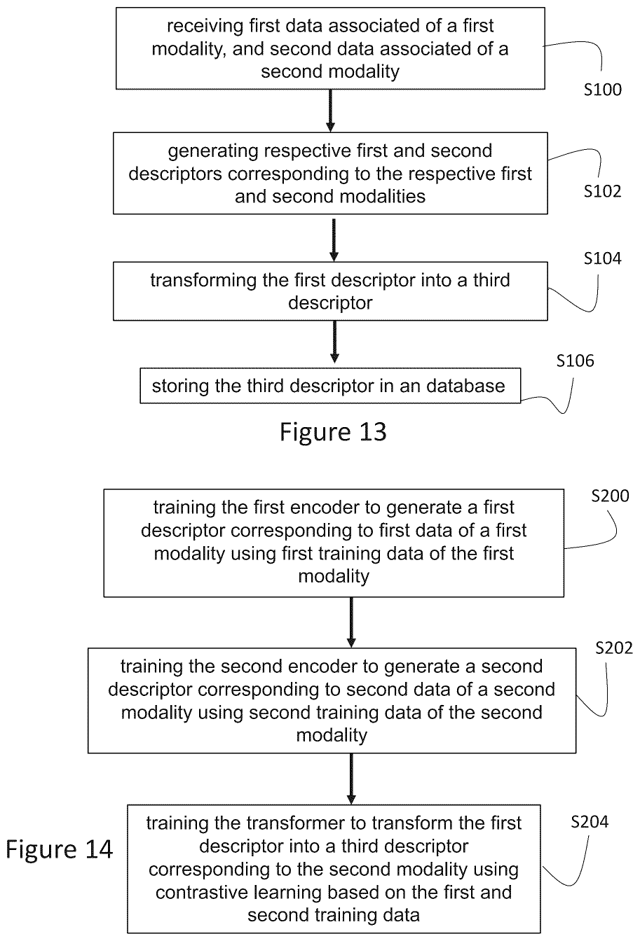

Whilst the above description provides detail relating to the embodiments, the subject-matter of the present disclosure may be summarised with reference to FIGS. 13 to 15.

With reference to FIG. 13, there is provided a computer-implemented method of generating a descriptor associated with data of a first modality. The method comprises: (at step S100) receiving first data associated of a first modality, and second data associated of a second modality, wherein the first and second modalities are different; (at step S102) generating respective first and second descriptors corresponding to the respective first and second modalities by encoding the first and second data using respective first and second encoders, the first and second encoders respectively trained based on first training data of the first modality and second training data of the second modality; (at step S104) transforming the first descriptor into a third descriptor, the third descriptor corresponding to the second modality; and (at step S106) storing the third descriptor in an database.

With reference to FIG. 14, there is provided a computer-implemented method of training a descriptor generator for generating a descriptor for indexing data from a first modality, the descriptor generator comprising a first encoder, a second encoder, and a transformer. The method comprises: (at step S200) training the first encoder to generate a first descriptor corresponding to first data of a first modality using first training data of the first modality; (at step S202) training the second encoder to generate a second descriptor corresponding to second data of a second modality using second training data of the second modality, wherein the first and second modalities are different; and (at step S204) training the transformer to transform the first descriptor into a third descriptor corresponding to the second modality using contrastive learning based on the first and second training data.

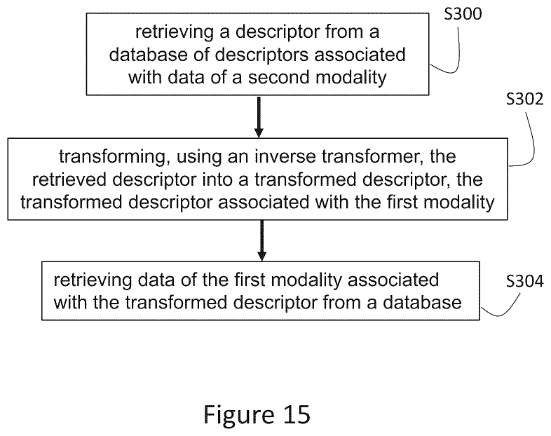

With reference to FIG. 15, there is provided a computer-implemented method of retrieving data of a first modality. The method comprises: (at step S300) retrieving a descriptor from a database of descriptors associated with data of a second modality; (at step S302) transforming, using an inverse transformer, the retrieved descriptor into a transformed descriptor, the transformed descriptor associated with the first modality, wherein the first and second modalities are different; and (at step S304) retrieving data of the first modality associated with the transformed descriptor from a database.

Whilst the foregoing embodiments have been described to illustrate the subject-matter of the present disclosure, the features of the embodiments are not to be taken as limiting the scope of protection. For the avoidance of doubt, the scope of protection is defined by the following claims.

1. A computer-implemented method of generating a descriptor associated with data of a first modality, the method comprising:
receiving first data associated with a first modality, and second data associated of a second modality, wherein the first and second modalities are different;
generating respective first and second descriptors corresponding to the respective first and second modalities by encoding the first and second data using respective first and second encoders, the first and second encoders respectively trained based on first training data of the first modality and second training data of the second modality;
transforming the first descriptor into a third descriptor, the third descriptor corresponding to the second modality; and
storing the third descriptor in a database.

2. The computer-implemented method of claim 1, wherein transforming the first descriptor into the third descriptor comprises:
decoding the first descriptor into decoded third data corresponding to the second modality using a decoder, the decoder trained to generate data of the second modality; and
encoding the third data to generate the third descriptor corresponding to the second modality using a third encoder.

3. The computer-implemented method of claim 1, wherein the first modality and the second modality respectively correspond to modality of a sensor used to record the respective data.

4. The computer-implemented method of claim 3, wherein the sensor comprises one of a LIDAR sensor, a RADAR sensor, and a camera.

5. The computer-implemented method of claim 1, wherein the first encoder and the second encoder are from respective auto encoders, and wherein the respective first descriptor and second descriptor is a representation corresponding to a bottle neck of the respective auto encoder.

6. The computer-implemented method of claim 5, wherein at least one of the respective auto encoders is a variational auto encoder.

7. A computer-implemented method of training a descriptor generator for generating a descriptor associated with data of a first modality, the descriptor generator comprising a first encoder, a second encoder, and a transformer, the method comprising:
training the first encoder to generate a first descriptor corresponding to first data of a first modality using first training data of the first modality;
training the second encoder to generate a second descriptor corresponding to second data of a second modality using second training data of the second modality, wherein the first and second modalities are different; and
training the transformer to transform the first descriptor into a third descriptor corresponding to the second modality using contrastive learning based on the first and second training data.

8. The computer-implemented method of claim 7, wherein training the transformer using contrastive learning comprises:
determining a distance between the second descriptor and the third descriptor; and
modifying the transformer to reduce the distance.

9. The computer-implemented method of claim 7, wherein the training transformer using contrastive learning comprises:
comparing, using a discriminator, the second descriptor and the second descriptor; and
determining if the third descriptor is real or fake using the discriminator.

10. The computer-implemented method of claim 7, wherein the descriptor generator further comprises an inverse transformer, and wherein the method further comprises:
transforming the third descriptor into a fourth descriptor using the inverse transformer;
computing a distance between the first descriptor and the fourth descriptor; and
modifying the inverse transformer to reduce the distance.

11. The computer-implemented method of claim 7, wherein the first modality and the second modality respectively correspond to a modality used to record the respective data.

12. The computer-implemented method of claim 11, wherein the sensor comprises one of a LIDAR sensor, a RADAR sensor, and a camera.

13. The computer-implemented method of claim 7, wherein the first encoder and the second encoder are each an encoder of an autoencoder.

14. The computer-implemented method of claim 13, wherein the autoencoder is a variational autoencoder.

15. A computer-implemented method of retrieving data of a first modality, the method comprising:
retrieving a descriptor from a database of descriptors associated with data of a second modality;
transforming, using an inverse transformer, the retrieved descriptor into a transformed descriptor, the transformed descriptor associated with the first modality, wherein the first and second modalities are different; and
retrieving data of the first modality associated with the transformed descriptor from a database.

16. The computer-implemented method of claim 15, wherein the first and second modalities each correspond to a modality of a sensor used to record the respective data.

17. The computer-implemented method of claim 16, wherein the sensor is one of a LiDAR sensor, a RADAR sensor, or a camera.

18. The computer-implemented method of claim 15, further comprising:
obtaining real-time data from a sensor of the first modality;
comparing the real-time data to the retrieved data; and
operating an autonomous vehicle to move based on the comparison.

19. A transitory, or non-transitory, computer-readable medium including instructions stored thereon that when executed by a processor, cause the processor to perform a method comprising:
receiving first data associated with a first modality, and second data associated of a second modality, wherein the first and second modalities are different;
generating respective first and second descriptors corresponding to the respective first and second modalities by encoding the first and second data using respective first and second encoders, the first and second encoders respectively trained based on first training data of the first modality and second training data of the second modality;
transforming the first descriptor into a third descriptor, the third descriptor corresponding to the second modality; and
storing the third descriptor in a database.
